(19) United States
(12) Patent Application Publication
(10) Pub. No.: US 2004/0091268 A1
(43) Pub. Date: May 13, 2004

(54) Transmitter optical sub-assembly

(75) Inventors: William K. Hogan, Rochester, MN (US); David Peter Gaio, Rochester, MN (US); Roger T. Lindquist, Dodge Center, MN (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA

(21) Appl. No.: 10/700,948

(22) Filed: Oct. 31, 2003

Related U.S. Application Data
(60) Provisional application No. 60/423,315, filed on Nov. 1, 2002.

(51) Int. Cl. H04B 10/00

(52) U.S. Cl. 398/117

(57) ABSTRACT

The invention relates to a transmitter optical sub-assembly (TOSA) for use in high data rate (10 Gb/s or higher) small form factor transceivers. A flexible cable electrical connector, a ceramic feedthrough, and a differential drive disposed adjacent the laser result in improved optical eye-diagrams with increased design margin. A heat spreader incorporated in the housing of the TOSA ensures constant performance at the high data rates.

### CROSS-REFERENCE TO RELATED APPLICATIONS

The present invention claims priority from U.S. Patent Application No. 60/423,315 filed Nov. 1, 2002, which is incorporated herein by reference.

### TECHNICAL FIELD

The present invention relates to a transmitter optical sub-assembly (TOSA), and in particular to a hermetically packaged TOSA for use in a small form factor transceiver designed for high bit rates (10 Gb/s or higher).

### BACKGROUND OF THE INVENTION

Small form factor transceivers are adapted to receive LC optical connectors with a transmitter (Tx) to receiver (Rx) port pitch of 6.25 mm, which is half the standard port pitch distance, 12.5 mm, found in SC transceivers. Conventional small form factor transceivers use Transistor-Outline (TO) can technology for packaging their TOSAs; however, recent demand for small form factor transceivers operating at high bit rates (>10 Gb/s) have necessitated modifications to the conventional TO can arrangement. In particular, the number of leads must be increased to at least six, and the lengths of the leads extending from the TO can must be minimized. The amount of heat dissipated from the TO can must be increased. Moreover, it is highly beneficial for some of the electrical components to be disposed adjacent the laser, which is impossible with the current TO can structure.

An object of the present invention is to overcome the shortcomings of the prior art by providing a TOSA for a small form factor transceiver operating at high bit rates.

### SUMMARY OF THE INVENTION

Accordingly, the present invention relates to A transmitter optical sub-assembly (TOSA) for mounting in a host opto-electronic device comprising:

a laser diode for generating an optical signal;

a monitor diode for monitoring output from the laser diode;

a housing for supporting the laser diode and the monitor diode;

a lens system for focusing the optical signal onto an optical fiber, which transmits the optical signal from the TOSA;

a window in a side of the housing forming a hermetic seal therewith for passing the optical signal therethrough;

a bore mounted outside of the housing for receiving an end of the optical fiber;

an electronic circuit, mounted in the housing, including circuitry for transmitting electronic signals to the laser diode;

a multi-layer ceramic feedthrough for transmitting electronic signals to the electronic circuit from the host device; and

an electrical connector extending from the ceramic feedthrough electrically connecting the host device with the ceramic feedthrough;

wherein the electrical connector comprises six leads;

wherein two of the leads are for transmitting RF signals to the laser diode;

wherein two of the leads are for transmitting DC bias signals to the laser diode;

wherein two of the leads are for transmitting signals to and from the monitor diode;

wherein the circuitry includes an impedance matching resistor electrically connected to at least one of the two leads for transmitting RF signals to the laser diode; and

wherein the circuitry includes an inductive choke component electrically connected to at least one of the two leads for transmitting DC bias signals to the laser diode.

### BRIEF DESCRIPTION OF THE DRAWINGS

The invention will be described in greater detail with reference to the accompanying drawings which represent preferred embodiments thereof, wherein:

FIG. 1 is an isometric view of an optical transceiver including the transmitter optical sub-assembly (TOSA) according to the present invention;

FIG. 2 is an isometric view of the TOSA according to the present invention;

FIG. 3 is an isometric cross-sectional view of the TOSA of FIG. 2;

FIG. 4 is an isometric view of the TOSA of FIGS. 1 and 2 from above with the cover removed;

FIG. 5 is a schematic diagram of the electronic leads extending from the TOSA of FIGS. 2 to 4;

FIG. 6 is an isometric view of the TOSA of FIGS. 2 to 5 with an alternative bore;

FIG. 7 is an isometric view of an alternative embodiment of the TOSA housing according to the present invention;

FIG. 8 is an isometric cross-sectional view of the TOSA of FIG. 7; and

FIG. 9 is a cross-sectional view of an alternative embodiment of the lens structure of the TOSA according to the present invention.

### DETAILED DESCRIPTION

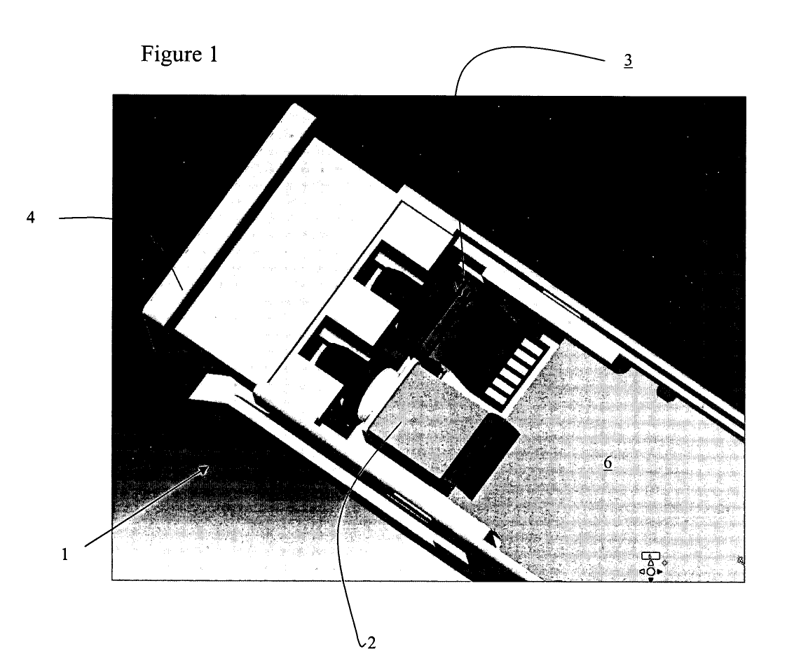

With reference to FIG. 1, an opto-electronic device, in the form of an optical transceiver 1, includes a transmitter optical sub-assembly (TOSA) 2 and a stacked chip receiver optical sub-assembly (ROSA) 3 mounted adjacent one another in a transceiver module 3. A duplex optical connector 4 is formed in the front end of the transceiver module 3 for receiving the ends of optical fibers (not shown), which optically couple the TOSA 2 and the ROSA 3 to an optical network. A circuit board 6 is electrically connected to the TOSA 2 and the ROSA 3 inside the transceiver module 3, and includes circuitry for controlling the TOSA 2 and the ROSA 3. An electrical connector (not shown) is electrically connected to the circuit board 6 for transmitting electrical signals between the circuit board 6 and a host device (not shown).

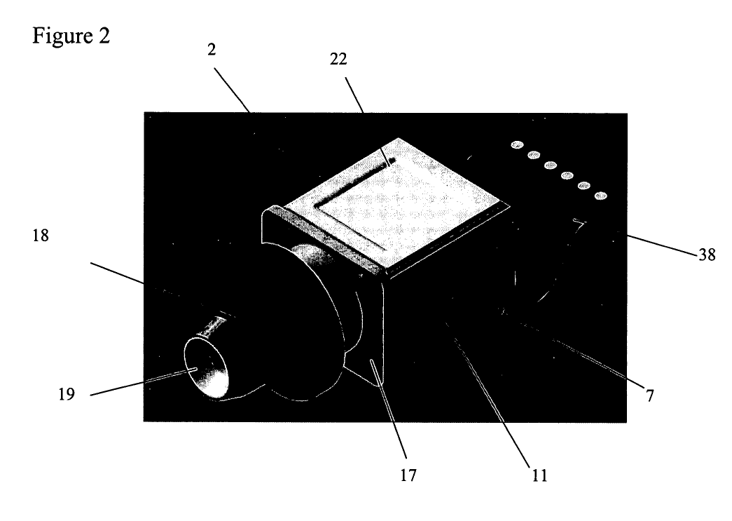

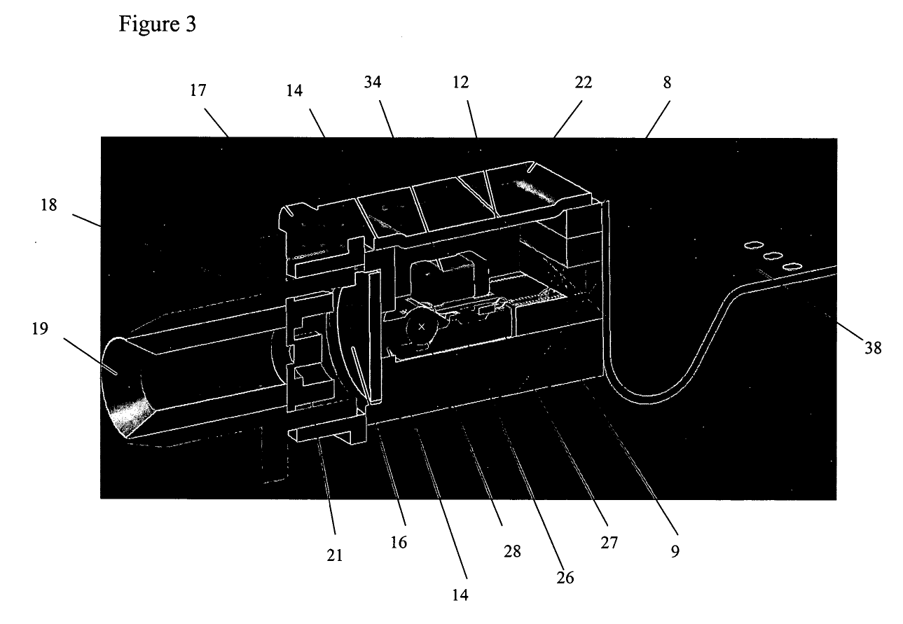

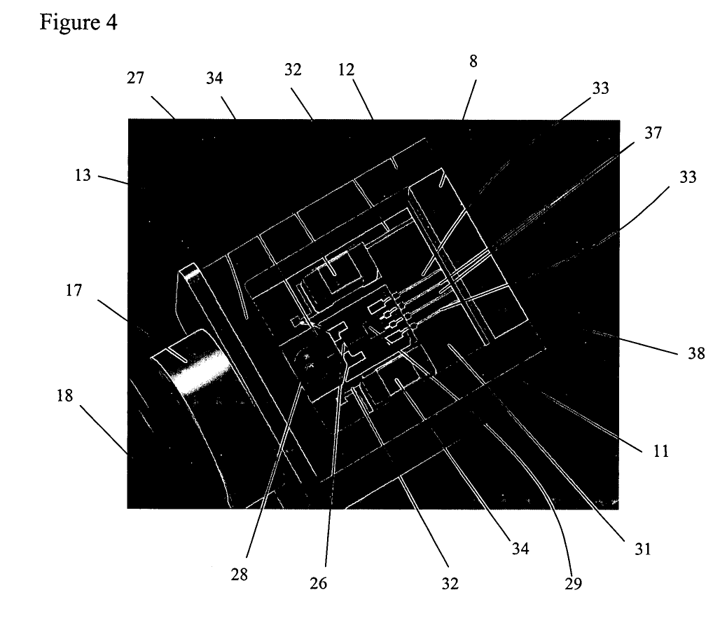

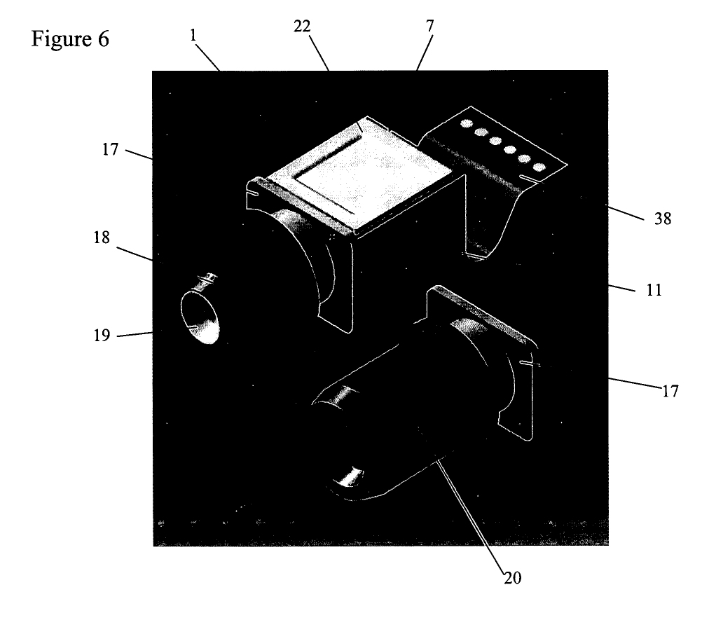

FIGS. 2 to 4 illustrate a first embodiment of the TOSA 2 according to the present invention, in which a hermetically sealed TOSA housing 7 includes a multi-layer ceramic feedthrough 8 at the rear end thereof, a Kovar® base 9, and Kovar® sidewalls 11 and 12. The front end of the housing 7 includes a Kovar® front wall 13 with an opening 14 extending therethrough. Hermetically sealing the opening 14, e.g. by brazing, is a transparent window 16. An annular, stainless-steel, bore-mounting flange 17 is mounted, e.g. welded, on the front wall 13 for receiving a stainless steel bore 18. A ceramic fiber bore 19 is provided inside the stainless steel bore 18, thereby forming an optical connector port for receiving an LC connector on an end of an optical fiber (not shown). An optical isolator 21 is positioned in the bore 18 adjacent the window 16 to prevent back reflections from reentering the housing 7 via the optical fiber. The bore-mounting flange 17 can accommodate any size of stainless steel bore 18, including an LC bore, as illustrated in FIGS. 1 to 4, and an SC bore 20 as illustrated in FIG. 6. A cover 22, made of a suitable material, e.g. Kovar® or stainless steel, is hermetically sealed to the top of feedthrough 8, the front wall 13, and side walls 11 and 12. During assembly, the upper surfaces of the feedthrough 8, the front wall 13 and the side walls 11 and 12 are polished to ensure that the upper surfaces are flush with one another. To facilitate assembly the upper surfaces are then metal plated before the cover 22 is welded thereto forming a hermetic seal. Kovar® is the preferred material, but any low thermal expansion material could be used.

Since the Tx to Rx pitch for a small form factor transceiver is 6.25 mm, the width of the housing 7 must be 6.0 mm or less. The housing illustrated in FIGS. 2 to 4 is actually 5.5 mm wide.

Inside the housing 7, an edge emitting semiconductor laser 26 is incorporated in a SiOB optical bench 27, which also includes a ball lens 28 and a monitor photodiode 29. In use, the laser 26 launches an optical signal through the lens 28, which focuses the optical signal onto the optical fiber (not shown) installed in the bore 19. A portion of the light, indicative of the laser output, is directed backwardly to the monitor photodiode 29, which is used in a feedback circuit to control the output of the laser 26.

To increase heat dissipation from the housing 7, a portion of the base 9 is removed, and replaced by a higher thermally conductive material, e.g. Copper Tungsten (CuW) acting as a heat spreader. Ideally, the optical bench 27 would be mounted directly on the heat spreader, and the heat spreader would be interfaced with a heat sink on the transceiver module 1 or the bottom wall thereof.

Alternatively, a thermal electric heater can be added to control the temperature of the TOSA.

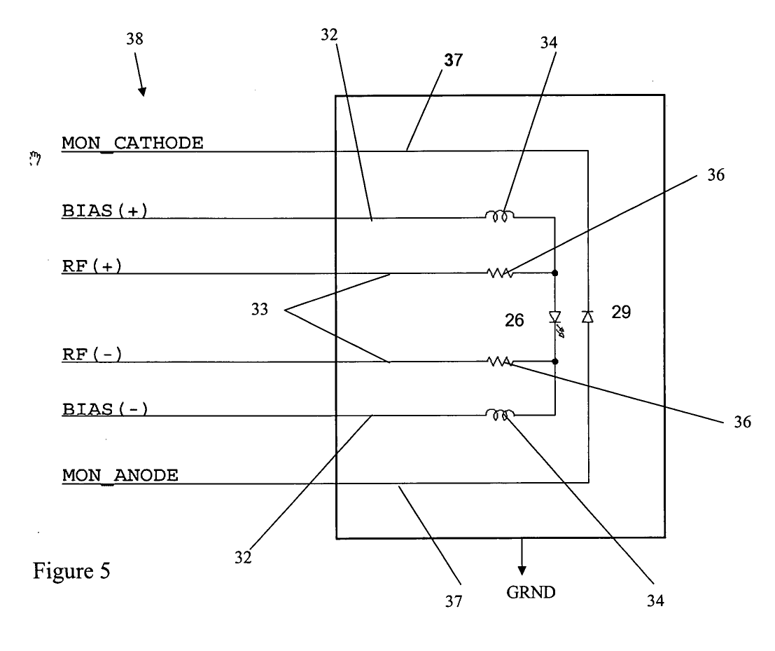

A ceramic substrate 31 extends contiguously from the feedthrough 8 inside the housing 7 around the optical bench 27 for supporting a differential drive circuit (FIG. 5), which electrically connects the laser 26 and the monitor photodiode 29 to the transceiver circuit board 6 via multi-layer feedthrough 8. Two trace leads 32 enable DC current to the fed to the laser 26, while two other trace leads 33 enable AC RF signals to be fed to the laser 26 for modulation thereof. SMT (Surface Mount Technology) inductive choke components 34 disposed in the trace leads 32 enable the DC current to be fed to the laser 26 without a reduction in the AC RF signal. For data rates greater than or equal to 10 Gb/s the choke components 34 must to connected very close to the laser 26 to prevent unwanted resonance that disrupt or degrade the signal transmission. For conventional data rates (2.5 Gb/s) the choke components could be mounted remote from the laser, i.e. outside the TO can, on the transceiver circuit board. Impedance matching film resistors 36, formed in the trace leads 33 or on the optical bench 27, provide a controlled impedance transmission of the high speed data signals from the transceiver circuit board 6 to the laser 26. The film resistors 36 match the laser impedance to the impedance of the transmission line and to the output impedance of the laser driver integrated circuit. Two additional trace leads 37 provide electrical communication with the monitor photodiode 29. Two additional leads would be required to control the thermal electric cooler, if required. The advantages of using the differential drive circuit are realized through faster rise/fall times, better symmetry in the rising and falling edges, and less duty cycle distortion. These improvements result in improved optical eye diagrams with increased design margin to specified eye mask limits.

To facilitate alignment of the TOSA 2 with the optical connector 4 and the circuit board 6, a flexible electric connector 38 is used to electrically connect the trace leads 32, 33, and 37 to the circuit board 6 via the feedthrough 8. A ground plane is established within one of the ceramic layers of the feedthrough 8 that is used to reference the controlled impedance RF connections 33. The housing ground would be connected to the ground on the flex connector 38 and is preferably connected to the housing 7.

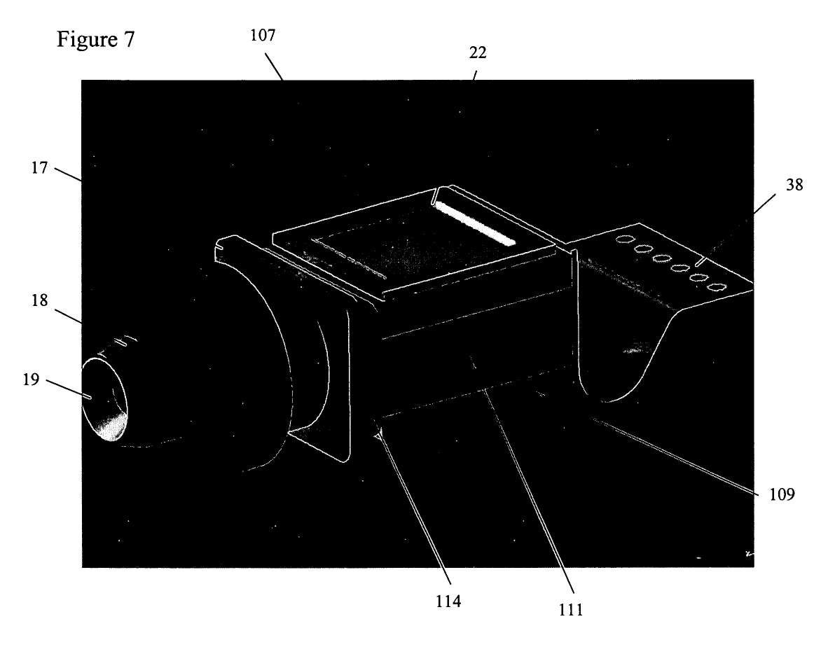

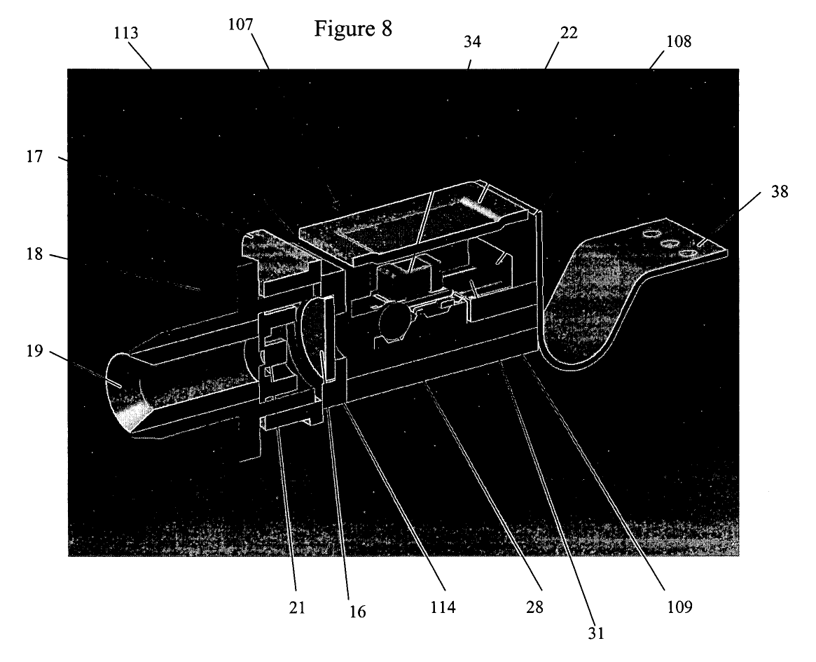

An alternative embodiment of the present invention is illustrated in FIGS. 7 and 8, in which most of the housing 107, i.e. the base 109, the front wall 113 and the side walls 111 and 112, along with the feedthrough 108 are all constructed out of multi-layer ceramic. A Kovar® flange 114 is brazed onto the front wall 113, which has been treated with a metal coating. The window 16 is then able to be correctly positioned and welded to the flange 114. The remaining elements are identical to those in the first embodiment.

An important aspect of the embodiment of the invention illustrated in FIGS. 1 to 4 is the ability to utilize a single ball lens 28. When coupling light from the laser 26 to a fiber using the single ball lens 28, it is desirable to mount the laser 26 very close to a first surface of the ball lens 28, e.g. 50 μm to 400 μm. The focal plane for which the fiber needs to be aligned and secured in place is then located approximately 3.0 mm away from an opposite surface of the ball lens 28, depending on the size thereof. The embodiment illustrated in FIGS. 1 to 4 is preferable to the total ceramic embodiment of FIGS. 7 and 8, because the thickness of the front wall of the housing 7 only depends on the thickness of the Kovar® front wall 13, while the front wall of the housing 107 depends on the ceramic front wall 113 and the flange 114. The increased thickness makes it very difficult to contain the optical isolator 21 and the mechanical alignment hardware in the overall housing design.

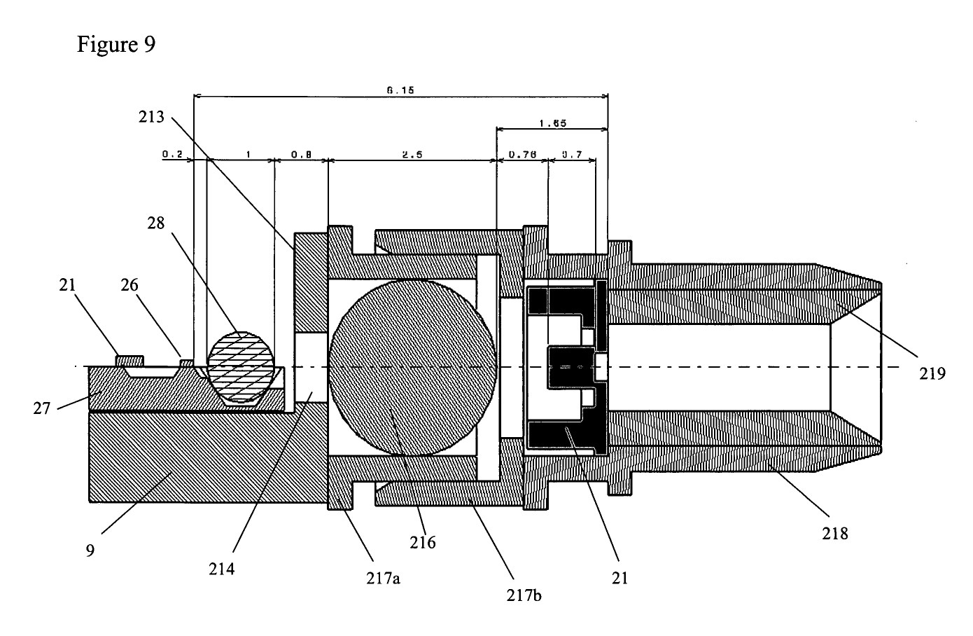

Accordingly, FIG. 9 illustrates an alternative embodiment of the invention, in which a second ball lens 216 is provided in place of the window 16. Cylindrical telescoping mounting flanges 217a and 217b secure the second ball lens 216 therebetween, hermetically sealing an opening 214. Elimination of the window 16, eliminates the necessity for the flange 114, so that the mounting flange 217a can be attached directly to the ceramic rear wall 213. A stainless steel bore 218, with a ceramic bore 219 and the isolator 21, is welded to the other mounting flange 217b. In this embodiment light launched from the laser 26 passes through the first lens 28, through the opening 214 in the rear wall 213, through the second lens 216, through the isolator 21 to the fiber (not shown).

We claim:

1. A transmitter optical sub-assembly (TOSA) for mounting in a host opto-electronic device comprising:
a laser diode for generating an optical signal;
a monitor diode for monitoring output from the laser diode;
a housing for supporting the laser diode and the monitor diode;
a lens system for focusing the optical signal onto an optical fiber, which transmits the optical signal from the TOSA;
a window in a side of the housing forming a hermetic seal therewith for passing the optical signal therethrough;
a bore mounted outside of the housing for receiving an end of the optical fiber;
an electronic circuit, mounted in the housing, including circuitry for transmitting electronic signals to the laser diode;
a multi-layer ceramic feedthrough for transmitting electronic signals to the electronic circuit from the host device; and
an electrical connector extending from the ceramic feedthrough electrically connecting the host device with the ceramic feedthrough;
wherein the electrical connector comprises six leads;
wherein two of the leads are for transmitting RF signals to the laser diode;
wherein two of the leads are for transmitting DC bias signals to the laser diode;
wherein two of the leads are for transmitting signals to and from the monitor diode;
wherein the circuitry includes an impedance matching resistor electrically connected to at least one of the two leads for transmitting RF signals to the laser diode; and
wherein the circuitry includes an inductive choke component electrically connected to at least one of the two leads for transmitting DC bias signals to the laser diode.

2. The TOSA according to claim 1, wherein the multi-layer ceramic feedthrough includes one layer for transmitting the RF signals, and one layer for transmitting the DC bias signals.

3. The TOSA according to claim 1, wherein the housing includes a bottom and four sides;
and wherein the four sides are comprised of multiple layers of ceramic.

4. The TOSA according to claim 1, wherein the housing includes a bottom and four sides;
and wherein three of the sides are comprised of a low thermal expansion material.

5. The TOSA according to claim 4, wherein the bottom includes a portion of thermally conductive material for dissipating heat from within the housing.

6. The TOSA according to claim 1, further comprising a bore mounting flange mounted on the housing, whereby any size of bore may be connected thereto for receiving any size of optical connector mounted on an end of the optical fiber.

7. The TOSA according to claim 1, wherein the lens system included a first and a second lens; wherein the first lens in disposed inside the housing adjacent the laser diode; and wherein the window comprises the second lens disposed outside of the housing for focusing the optical signal from the first lens onto the optical fiber.

8. The TOSA according to claim 1, wherein the electrical connector is comprised of a flexible electrical connector.

9. The TOSA according to claim 1, wherein the housing is hermetically sealed.

10. The TOSA according to claim 1, wherein the housing is less than 6.0 mm wide.

11. The TOSA according to claim 1, further comprising temperature control means for controlling the temperature inside the housing.

12. The TOSA according to claim 11, wherein the temperature control means comprises a section of thermally conductive material forming part of the housing.

13. The TOSA according to claim 1, wherein the circuitry is formed in a ceramic substrate extending contiguously from the ceramic feedthrough.
